(19) United States
(12) Patent Application Publication
(10) Pub. No.: US 2009/0106690 A1
(43) Pub. Date: Apr. 23, 2009

(54) METHOD AND APPARATUS FOR SHARING SCREEN BETWEEN APPLICATIONS BASED ON DIFFERENT KINDS OF GRAPHIC SYSTEMS

(75) Inventors: Hye-kyung KOH, Incheon Metropolitan City (KR); Da-na JUNG, Busan Metropolitan City (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD., Suwon-si (KR)

(21) Appl. No.: 12/132,700

(22) Filed: Jun. 4, 2008

(30) Foreign Application Priority Data
Oct. 23, 2007 (KR) 10-2007-0106739

(51) Int. Cl. G06F 3/048

(52) U.S. Cl. 715/790

(57) ABSTRACT

Provided are a method and apparatus for sharing a screen between applications based on different kinds of graphic systems when the applications are shown or hidden. The method includes the operations of setting a default graphic system, and controlling an operation of showing or hiding the applications based on different kinds of graphic systems, using the default graphic system.

### CROSS-REFERENCE TO RELATED PATENT APPLICATION

This application claims priority from Korean Patent Application No. 10-2007-0106739, filed on Oct. 23, 2007, in the Korean Intellectual Property Office, the disclosure of which is incorporated herein in its entirety by reference.

### BACKGROUND OF THE INVENTION

1. Field of the Invention

Methods and apparatuses consistent with the present invention relate to screen sharing between a plurality of applications, and more particularly, to sharing a screen between applications based on different kinds of graphic systems.

2. Description of the Related Art

An example of an apparatus having a function of providing an application based on a graphic system is a digital television (DTV). In order to satisfy various needs of users, the kinds of applications installed in apparatuses such as DTVs have gradually diversified.

Applications used in DTVs may be roughly classified into resident applications and download applications. The resident applications are also called native applications. The resident applications are not associated with a graphic system used in middle ware and are installed as defaults in apparatuses. A graphic system is also called as a window system, a window manager, or a graphic library. Different kinds of graphic-system-based applications may be defined as different kinds of graphic-library-based applications. Middleware denotes software that connects applications to each other in order to exchange data between the applications. In the case of DTVs, resident applications may be banner applications or volume applications. A download application operates based on a graphic system which is used in middleware. There are various kinds of download applications such as a weather application, a stock application, an application providing player information during a sports game, a quiz application, etc.

A resident application and a download application may be simultaneously displayed on one screen. The resident application may be created using a graphic system and also created using a graphic driver library. However, the download application is created using only a graphic system.

Download applications are managed using an identical graphic system. When the graphic system performs a showing operation on applications managed by the graphic system itself, the graphic system paints or draws windows for applications on a screen in a Z sequence (i.e., a sequence where windows overlap each other). When the graphic system performs a hiding operation on the applications, the graphic system automatically restores a portion of a window of an application that is overlapped and hidden by a window of another application that is to be hidden.

However, a resident application and a download application may be managed using different graphic systems. For example, the resident application may be managed by a WinCE graphic system, and the download application may be managed by an X-window graphic system or by a graphic system that uses an application programming interface (API) for a graphic device driver. When windows of a resident application and a download application managed by different kinds of graphic systems overlap each other, a problem occurs during the hiding operation. More specifically, when a window of a resident application is shown over a window of a download application and then hidden, an area of the window of the download application, which was overlapped by the window of the resident application, cannot be restored.

This problem will now be described in greater detail with reference to FIGS. 1 through 4. FIG. 1 is a screen on which window 1 and window 2 of a download application overlap each other. FIG. 2 is a screen on which window 1 illustrated in FIG. 1 is hidden from the screen illustrated in FIG. 1. FIG. 3 is a screen on which the windows illustrated in FIG. 1 are overlapped by a window of a resident application. FIG. 4 is a screen on which the window of the resident application hides from the screen illustrated in FIG. 3. If there is an overlapping segment 101 between the windows 1 and 2 of the download application as illustrated in FIG. 1 and the window 1 is hidden, a graphic system that manages the windows 1 and 2 recovers an overlapped area 101 and thus the screen illustrated in FIG. 2 is obtained. Meanwhile, when the window of the resident application, which is not managed by the graphic system for managing the windows 1 and 2, overlaps the windows 1 and 2 as illustrated in FIG. 3, if the resident window is hidden, portions of the windows 1 and 2 that are overlapped by the window of the resident window are not recovered as illustrated in FIG. 4.

A resident application and a download application that are managed by different kinds of graphic systems denote applications based on different kinds of graphic systems.

In a related art method of solving this problem, when middleware is ported to a DTV, a resident application may be newly written using the library of a graphic system used in the middleware.

### SUMMARY OF THE INVENTION

Exemplary embodiments of the present invention overcome the above disadvantages and other disadvantages not described above. Also, the present invention is not required to overcome the disadvantages described above, and an exemplary embodiment of the present invention may not overcome any of the problems described above.

The present invention provides a method and apparatus for sharing a screen between applications based on different kinds of graphic systems when the applications are shown or hidden.

According to an aspect of the present invention, there is provided a method of sharing a screen between applications based on different kinds of graphic systems, the method comprising the operations of setting a default graphic system and controlling an operation of showing or hiding the applications based on different kinds of graphic systems, by using the default graphic system.

In the operation of setting the default graphic system, a graphic system for managing a download application may be set as the default graphic system.

The operation of controlling the showing or hiding operation may include the sub-operations of: registering information about a resident application in the default graphic system; when a showing event signal for the download application is generated, processing the operation of showing the download application in consideration of the resident application by using the default graphic system; and when a hiding event signal for the resident application is generated, processing the operation of hiding the resident application in consideration of the download application by using the default graphic system, wherein information about the resident application comprises a paint function for the resident application, and the paint function comprises information about a location and size of the resident application.

The operation of registering the information about the resident application may include the sub-operations of: generating the resident application by using a resident application management unit for managing the resident application; registering the information about the resident application in the default graphic system by using a registration function called from the default graphic system; and when the default graphic system returns an identifier of the resident application to the resident application, storing the identifier in the resident application.

In the operation of processing the operation of showing the download application, the operation of showing the download application may be processed so that a window of the resident application is shown over a window of the download application.

In the operation of processing the operation of hiding the resident application, the operation of hiding the resident application may be processed so that a window of a download application partially overlapped by a window of the resident application can be recovered while the window of the resident application is being cleared.

According to another aspect of the present invention, there is provided an apparatus for sharing a screen between applications based on different kinds of graphic systems, the apparatus comprising: a screen display unit displaying a window of at least one application; a storage unit storing applications that is to be displayed on the screen display unit; and a control module setting a default graphic system and controlling an operation of showing or hiding the at least one application based on different kinds of graphic systems by using the default graphic system, wherein the control module controls information stored in the storage unit while controlling the operation of showing or hiding the at least one application based on different kinds of graphic systems.

### BRIEF DESCRIPTION OF THE DRAWINGS

The above and other aspects of the present invention will become more apparent by describing in detail exemplary embodiments thereof with reference to the attached drawings in which:

FIG. 1 is a screen on which window 1 and window 2 of a download application are overlapped;

FIG. 2 is a screen on which window 1 illustrated in FIG. 1 is hidden;

FIG. 3 is a screen on which the windows illustrated in FIG. 1 are overlapped by a window of a resident application;

FIG. 4 is a screen on which the window of the resident application is hidden from the window image illustrated in FIG. 3;

FIG. 5 is a block diagram of a screen sharing apparatus according to an exemplary embodiment of the present invention;

FIG. 6 illustrates a relationship between a back buffer and a screen display unit that are included in the screen sharing apparatus illustrated in FIG. 5;

FIG. 7 is a flowchart of a screen sharing method according to an exemplary embodiment of the present invention;

FIG. 8 is a flowchart of a showing or hiding control operation included in the screen sharing method illustrated in FIG. 7;

FIG. 9 is a flowchart of an operation of registering information about a resident application in a default graphic system, where the operation is included in the showing or hiding operation control operation illustrated in FIG. 8;

FIG. 10 is a flowchart of an operation of processing a showing or hiding event signal for a download application, where the operation is included in the showing or hiding operation control operation illustrated in FIG. 8;

FIG. 11 is a flowchart of showing-event signal processing performed during an operation of processing a showing or hiding event signal for a resident application, where the operation is included in the showing or hiding operation control operation illustrated in FIG. 8; and

FIG. 12 is a flowchart of hiding-event signal processing performed during the operation of processing a showing or hiding event signal for a resident application, where the operation is included in the showing or hiding operation control operation illustrated in FIG. 8.

### DETAILED DESCRIPTION OF EXEMPLARY EMBODIMENTS OF THE INVENTION

The present invention provides a method and apparatus for sharing a screen between applications based on different kinds of graphic systems, by which, when the applications based on different kinds of graphic systems are shown or hidden on a single screen, a graphic system for managing download applications is set as a default graphic system, the default graphic system for managing download applications controls all applications to be shown or hidden, a paint function of resident applications is registered as a callback in the default graphic system, and download applications and resident applications share a single back buffer. In addition, the screen sharing method and apparatus according to the present invention enables windows of a resident application to be always shown over windows of a download application.

The present invention will now be described more fully with reference to the accompanying drawings, in which exemplary embodiments of the invention are shown.

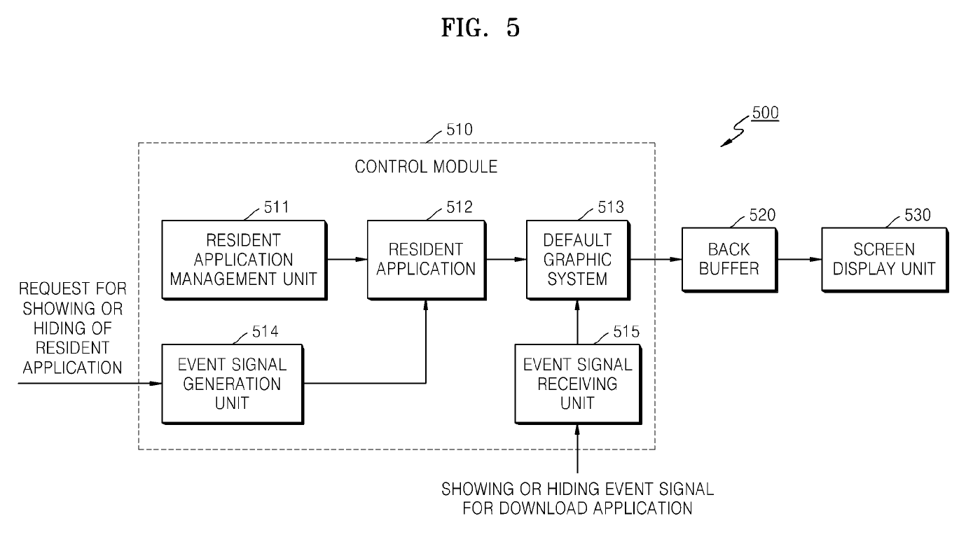

FIG. 5 is a block diagram of an apparatus 500 for sharing a screen between applications based on different kinds of graphic systems, according to an exemplary embodiment of the present invention. Referring to FIG. 5, the apparatus 500 includes a control module 510, a back buffer 520, and a screen display unit 530.

The control module 510 sets a default graphic system. When the apparatus 500 is applied to a digital television (DTV), a graphic system may be roughly divided into a graphic system for resident applications and a graphic system for download applications. When the graphic system is divided as described above, the control module 510 sets the graphic system for download applications to be the default graphic system.

When the default graphic system is set, the control module 510 controls a showing or hiding operation with respect to the applications based on different kinds of graphic systems by using the default graphic system. The control module 510 includes a resident application management unit 511, a resident application 512, a default graphic system 513, an event signal generation unit 514, and an event signal receiving unit 515.

The resident application management unit 511 generates the resident application 512 when the apparatus 500 is initialized. The resident application 512 registers itself in the default graphic system 513 by calling a registration function from the default graphic system 513. The registration function may be defined as a paint function of the resident application 512. The paint function, which is a callback function, may be defined to include the value, position, and magnitude of the back buffer 520 for the resident application 512. In other words, the paint function may be defined as “paint(buffer, x, y, w, h, . . . )”, where buffer denotes a location in the back buffer 520 where the resident application 512 is stored.

According to the called registration function, the resident application 512 is registered in a resident application list existing in the default graphic system 513, and then a handle value is returned to the resident application 512. Accordingly, the resident application list existing in the default graphic system 513 includes handle values of resident applications, a function pointer of a paint function, the locations and sizes of windows of the resident applications, and the other information associated with the resident applications.

The resident application 512 stores the returned handle value. The handle value is used as an identifier with which the default graphic system 513 distinguishes the resident application 512 from others. Accordingly, the handle value can be defined as an identifier.

The event signal generation unit 514 generates a showing event signal or a hiding event signal according to a showing or hiding request for a resident application. The showing or hiding request for a resident application is received from an external source. For example, the showing or hiding request for a resident application may be generated according to a user's command and input to the event signal generation unit 514. The event signal generation unit 514 transmits the generated showing or hiding event signal to the resident application 512. When receiving the showing event signal, the resident application 512 transmits a requestPaint function to the default graphic system 513. When receiving the hiding event signal, the resident application 512 transmits a requestHide function to the default graphic system 513.

The event signal receiving unit 515 receives a showing or hiding event signal for download applications. The showing or hiding event signal for download applications may be input to the event signal receiving unit 515 via a network. Alternatively, the showing or hiding event signal for download applications may be generated according to a user's demand and input to the event signal receiving unit 515. The event signal receiving unit 515 transmits the download application showing or hiding event signal to the default graphic system 513.

When receiving the requestPaint function from the resident application 512, the default graphic system 513 paints the resident application 512 on the back buffer 520. In other words, the default graphic system 513 stores the resident application 512 on the back buffer 520. When receiving the requestHide function from the resident application 512, the default graphic system 513 clears the resident application 512 from the back buffer 520 and, if a download application partially overlapped by the cleared resident application 512 exists, paints (i.e., stores) the download application on the back buffer 520 so that the overlapped portion of the download application can be recovered.

When receiving the showing event signal for a download application, the default graphic system 513 paints the download application on the back buffer 520 and controls the operation of showing the download application. At this time, if there exists a resident application to overlap a window of the currently shown download application, the default graphic system 513 paints the download application on the back buffer 520 so that the resident application can be shown over the download application.

When receiving the hiding event signal for a download application, the default graphic system 513 checks whether another download application that is overlapped by the download application to be currently hidden exists. If the another download application that is overlapped by the download application to be currently hidden exists, the default graphic system 513 controls the operation of hiding the to-be-hidden download application so that a window of the overlapped download application can be recovered.

More specifically, when showing a download application on the screen display unit 530, the default graphic system 513 paints application information on the back buffer 520 so that a window of the resident application 510 can be shown over a window of the download application. When hiding a download application from the screen display unit 530, the default graphic system 513 first checks if the to-be-hidden download application has partially overlapped a window of another download application. Thereafter, if the to-be-hidden download application has partially overlapped a window of another download application, the default graphic system 513 paints application information on the back buffer 520 so that the overlapped portion of the window of the download application under the to-be-hidden download application can be recovered.

On the other hand, when hiding a resident application from the screen display unit 530, the default graphic system 513 clears information about the resident application stored in the back buffer 520 and simultaneously paints information about a download application partially overlapped by a window of the resident application to the back buffer 520, so that a window of the download application partially overlapped by a window of the resident application can be recovered. When showing a resident application on the screen display unit 530, the default graphic system 513 paints information about the resident application on the back buffer 520 so that the resident application can always be shown over a download application.

The back buffer 520 clears information stored therein or stores (i.e., paints) information therein by using the default graphic system 513 included in the control module 510. The back buffer 520 may also be called a storage unit, because the default graphic system 513 stores a window of an application thereon before being shown on the screen display unit 530.

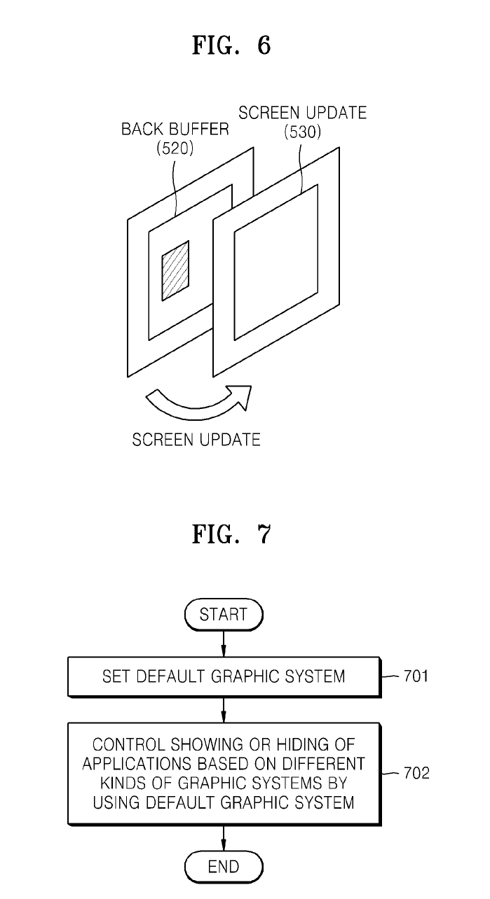

The screen display unit 530 displays an image representing applications painted on the back buffer 520. A relationship between the back buffer 520 and the screen display unit 530 can be expressed as illustrated in FIG. 6. Referring to FIG. 6, an image displayed on the screen display unit 530 is updated on the basis of the information stored in the back buffer 520.

Referring back to FIG. 5, the control module 510 of the screen sharing apparatus 500 including the single resident application management unit 511, the single resident application 512, the single event signal generation unit 514, and the single event signal receiving unit 515 is illustrated. However, according to the number of resident applications capable of being generated from a device employing the screen sharing apparatus 500, the control module 510 may include a plurality of resident application management units, a plurality of resident applications, and a plurality of event signal generation units. According to the number of download applications capable of being generated from the device employing the screen sharing apparatus 500, the control module 510 may include a plurality of event signal receiving units.

FIG. 7 is a flowchart of a screen sharing method according to an exemplary embodiment of the present invention. Referring to FIG. 7, first, a default graphic system is set in operation 701. The default graphic system is set to be a graphic system for managing download applications. Even when a device to which the exemplary embodiment of the present invention is applied operates using different kinds of graphic systems, the graphic system for managing download applications is set as the default graphic system as described above with reference to FIG. 5.

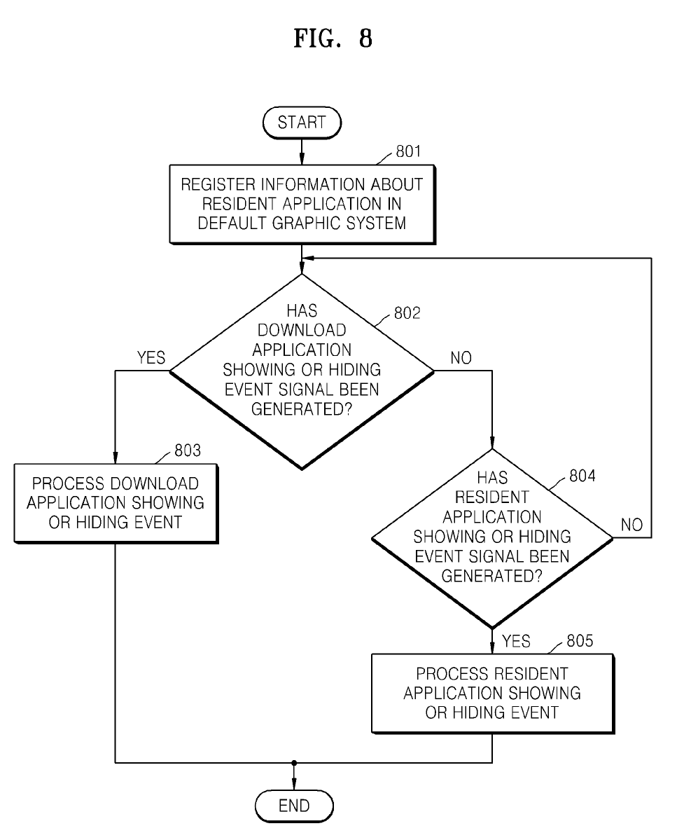

Next, the operation of showing or hiding applications based on different kinds of graphic systems is controlled using the default graphic system, in operation 702. FIG. 8 is a flowchart of the showing or hiding operation control operation 702 illustrated in FIG. 7. The operation 702 will now be described in greater detail with reference to FIGS. 5 and 8.

First, in operation 801, information about the resident application 512 is registered in the default graphic system 513. At this time, the information about the resident application 512 can be registered by calling the registration function from the default graphic system 513 as described above with reference to FIG. 5. The information about the resident application 512 may be defined as a paint function, which is similar to that defined above with reference to FIG. 5. A paint function as defined above with reference to FIG. 5 can only be called by the default graphic system 513. Accordingly, the requestPaint function and the requestHide function are added to the resident application 512. The requestPaint function may be called from the default graphic system 513, and the requestHide function may be called from an external source. The paint function is registered as a callback function in the default graphic system 513 and then called therefrom when a window of the resident application 512 is shown on the screen display unit 530.

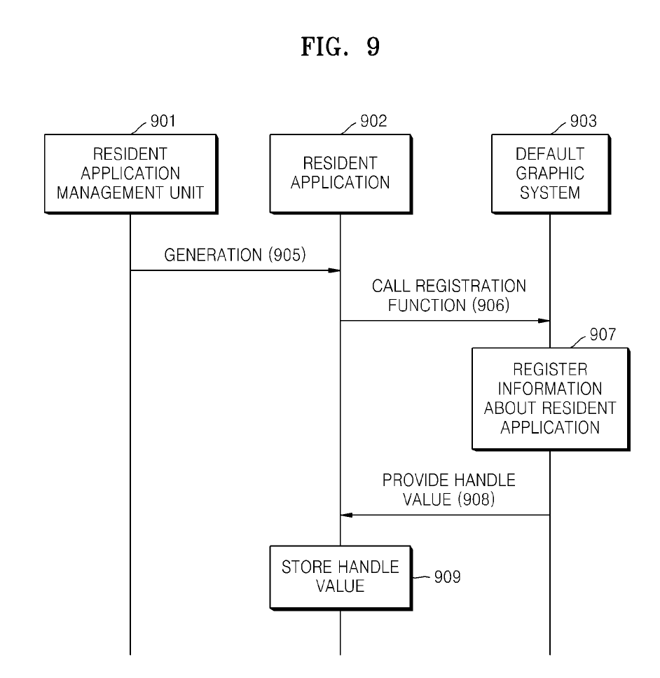

FIG. 9 is a flowchart of the operation 801. Referring to FIG. 9, in operation 905, a resident application management unit 901 generates a resident application 902 upon initialization. In operation 906, the resident application 902 calls a registration function from a default graphic system 903. In operation 907, the default graphic system 903 registers information about the resident application 902. In operation 908, the default graphic system 903 provides a handle value to the resident application 902. In operation 909, the resident application 902 stores the handle value. The resident application management unit 901, the resident application 902, and the default graphic system 903 illustrated in FIG. 9 correspond to the resident application management unit 511, the resident application 512, and the default graphic system 513 illustrated in FIG. 5, respectively.

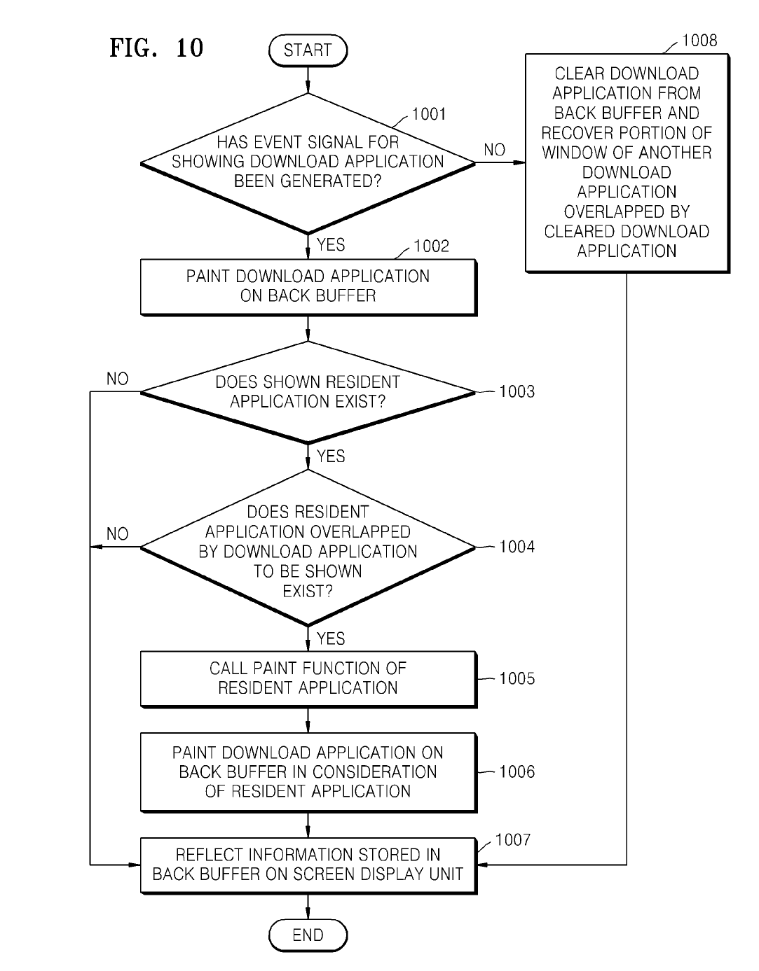

Referring back to FIG. 8, when it is determined in operation 802 that the download application showing or hiding event signal has been generated, the default graphic system 513 processes the download application showing or hiding event signal in consideration of the resident application, in operation 803. FIG. 10 is a flowchart of the operation 803.

Referring to FIGS. 5 and 10, in operation 1001, it is determined whether a showing event signal for a download application has been generated. If the showing event signal for a download application has been generated, the download application is painted on the back buffer 520, in operation 1002.

In operation 1003, it is determined whether a shown resident application exists. In operation 1004, it is determined whether the shown resident application is overlapped by the download application to be shown. In operation 1005, if it is determined in operations 1003 and 1004 that the shown resident application exists and is overlapped by the download application to be shown, a paint function of the shown resident application is called. In operation 1006, a download application is painted on the back buffer 520 in consideration of the resident application. In operation 1007, the information stored (i.e., painted) in the back buffer 520 is displayed on the screen display unit 530. The operation 1007 denotes the update of a screen displayed on the screen display unit 530 on the basis of the information stored in the back buffer 520.

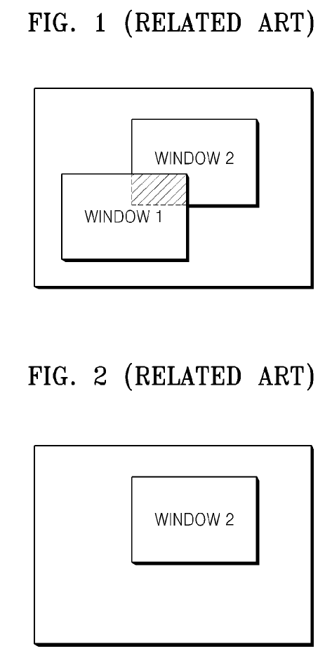

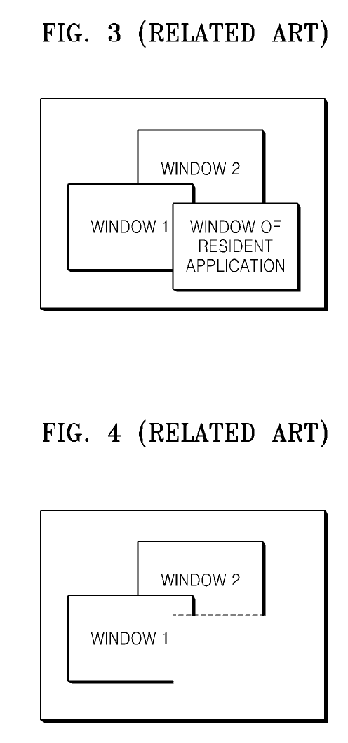

On the other hand, if it is determined in operation 1001 that no showing event signals for a download application have been generated but a hiding event signal for a download application has been generated, the download application is cleared from the information stored in the back buffer 520, and a portion of a window of another download application overlapped by the cleared download application is recovered, in operation 1008. The recovered download application is shown behind the cleared download application. For example, the download application having the to-be-recovered portion corresponds to the window 2 of FIG. 1 and the cleared download application corresponds to the window 1 of FIG. 1. In other words, the operation 1008 is followed by the operation 1007, in which the information stored in the back buffer 520 is displayed on the screen display unit 530.

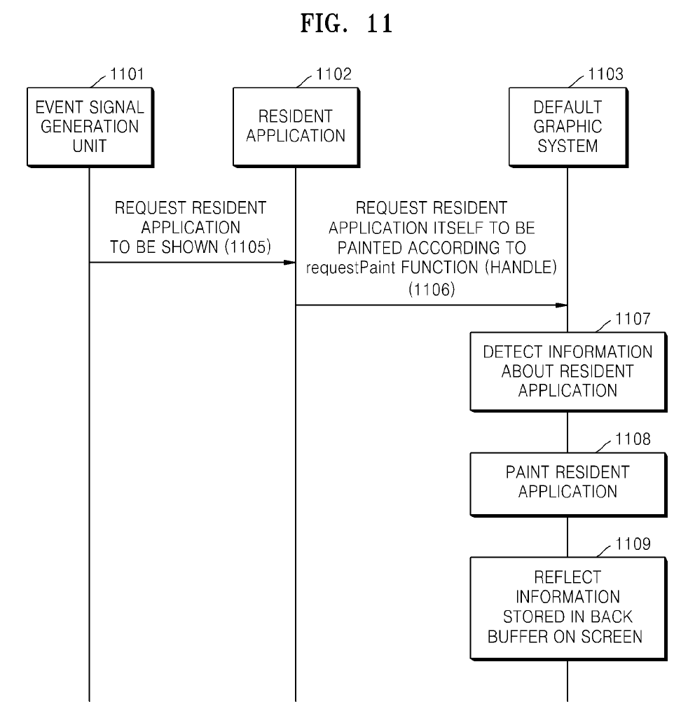

Referring back to FIG. 8, if it is determined in operation 802 that no showing or hiding event signals for the download application have been generated, it is determined whether a showing or hiding event signal for a resident application has been generated, in operation 804. If it is determined in operation 804 that the showing or hiding event signal for a resident application has been generated, the default graphic system 513 processes the resident application showing or hiding event signal, in operation 805. FIG. 11 is a flowchart of showing-event signal processing for the resident application performed during operation 805.

Referring to FIG. 11, when a resident application is requested to be shown, an event signal generation unit 1101 generates a showing event signal in operation 1105. Accordingly, a resident application 1102 requests a default graphic system 1103 to paint the resident application 1102 itself on the back buffer 520 according to the requestPaint function, in operation 1106. When the default graphic system 1103 calls the requestPaint function, the default graphic system 1103 is informed of which resident application is to be painted by using a handle value as a parameter. The default graphic system 1103 detects information about the location of the resident application stored in the resident application list and information about a paint function by using the handle value in operation 1107, and paints the resident application on the back buffer 520 in operation 1108. Since the resident application is shown on the active window of the screen display unit 530, there is no need to consider whether it is overlapped by a download application. Next, in operation 1109, the information stored in the back buffer 520 is displayed on the screen of the screen display unit 530. The event signal generation unit 1101, the resident application 1102, and the default graphic system 1103 illustrated in FIG. 11 correspond to the event signal generation unit 514, the resident application 512, and the default graphic system 513 illustrated in FIG. 5, respectively.

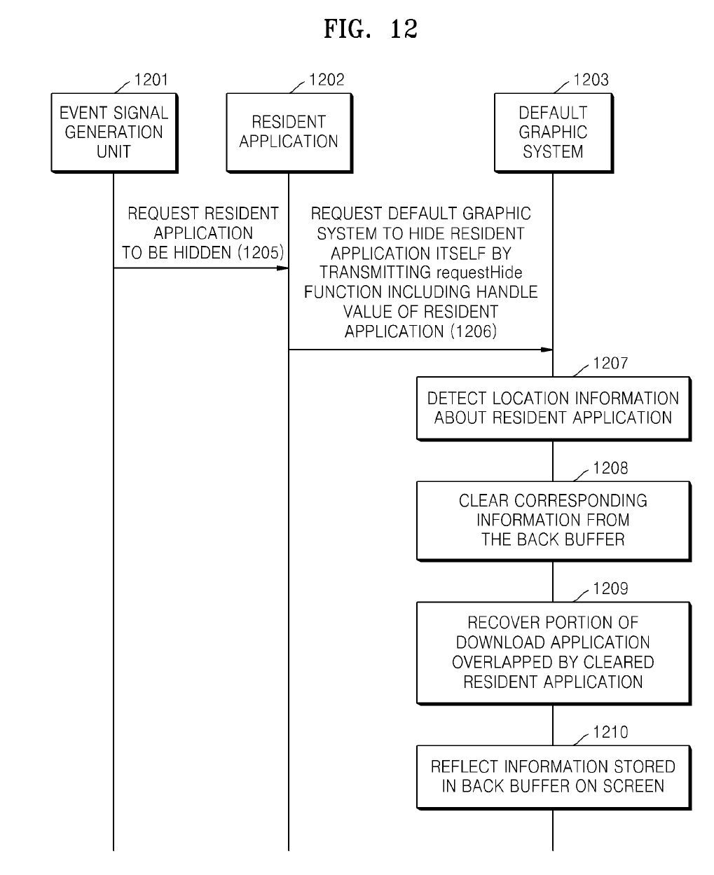

FIG. 12 is a flowchart of hiding-event signal processing for the resident application performed during the operation 805 illustrated in FIG. 8.

Referring to FIG. 12, when a resident application is requested to be hidden, an event signal generation unit 1201 generates a hiding event signal in operation 1205. A resident application 1202 requests a default graphic system 1203 to hide the resident application 1202 itself by transmitting a requestHide function including the handle value of the resident application 1202 itself to the default graphic system 1203, in operation 1206. In operation 1207, the default graphic system 1203 detects information about the location of the resident application 1202 stored in the resident application list by using the handle value. In operation 1208, the default graphic system 1203 clears corresponding information stored in the back buffer 520 by using the detected location information. In operation 1209, if there is a download application that is overlapped by a resident application corresponding to the cleared information, the default graphic system 1203 recovers the overlapped portion of the download application. Next, in operation 1210, the information stored in the back buffer 520 is displayed on the screen of the screen display unit 530. The event signal generation unit 1201, the resident application 1202, and the default graphic system 1203 illustrated in FIG. 12 correspond to the event signal generation unit 1101, the resident application 1102, and the default graphic system 1103 illustrated in FIG. 11, respectively.

Referring back to FIG. 8, if it is determined in operation 804 that no showing or hiding event signals for a resident application have been generated, the process returns to operation 802.

In a method and apparatus for sharing a screen between applications based on different kinds of graphic systems according to the present invention, problems associated with the management of a plurality of applications which use different kinds of graphic systems but exist in a single device can be solved.

For example, when middleware is ported to a DTV and a window of a resident application is hidden, a window of a download application partially overlapped by the resident application can be recovered without needing to newly write a resident application on the basis of a library of a graphic system which is used in the middleware.

A method for sharing a screen between applications based on different kinds of graphic systems according to the exemplary embodiment of the present invention can be embodied as computer readable codes on a computer readable recording medium. The computer readable recording medium is any data storage device that can store data which can be thereafter read by a computer system. Examples of the computer readable recording medium include read-only memory (ROM), random-access memory (RAM), CD-ROMs, magnetic tapes, floppy disks, and optical data storage devices. The computer readable recording medium can also be distributed over network coupled computer systems so that the computer readable code is stored and executed in a distributed fashion.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A method of sharing a screen between applications based on different kinds of graphic systems, the method comprising:
setting a default graphic system; and
controlling an operation of showing or hiding the applications based on the different kinds of graphic systems, by using the default graphic system.

2. The method of claim 1, wherein in the setting of the default graphic system, a graphic system for managing a download application is set as the default graphic system.

3. The method of claim 2, wherein the controlling of the showing or hiding operation comprises:
registering information about a resident application in the default graphic system;
when a showing event signal for the download application is generated, processing the operation of showing the download application in consideration of the resident application by using the default graphic system; and
when a hiding event signal for the resident application is generated, processing the operation of hiding the resident application in consideration of the download application by using the default graphic system,
wherein information about the resident application comprises a paint function for the resident application, and the paint function comprises information about a location and a size of the resident application.

4. The method of claim 3, wherein the registering of the information about the resident application comprises:
generating the resident application by using a resident application management unit for managing the resident application;
registering the information about the resident application in the default graphic system by using a registration function called from the default graphic system;
returning an identifier of the resident application to the resident application, and
when the default graphic system returns the identifier of the resident application to the resident application, storing the identifier in the resident application.

5. The method of claim 4, wherein in the processing of the operation of showing the download application, the operation of showing the download application is processed so that a window of the resident application is shown over a window of the download application.

6. The method of claim 3, wherein in the processing of the operation of showing the download application, the operation of showing the download application is processed so that a window of the resident application is shown over a window of the download application.

7. The method of claim 4, wherein in the processing of the operation of hiding the resident application, the operation of hiding the resident application is processed so that a window of the download application partially overlapped by a window of the resident application may be recovered while the window of the resident application is being cleared.

8. The method of claim 3, wherein in the processing of the operation of hiding the resident application, the operation of hiding the resident application is processed so that a window of the download application partially overlapped by a window of the resident application may be recovered while the window of the resident application is being cleared.

9. An apparatus for sharing a screen applications based on different kinds of graphic systems, the apparatus comprising:
a screen display unit which displays a window of at least one application;
a storage unit which stores applications that are to be displayed on the screen display unit; and
a control module which sets a default graphic system and controls an operation of showing or hiding the at least one application based on different kinds of graphic systems by using the default graphic system,
wherein the control module controls information stored in the storage unit while controlling the operation of showing or hiding the at least one application based on different kinds of graphic systems.

10. The apparatus of claim 9, wherein the control module sets the default graphic system to be a graphic system for managing a download application.

11. The apparatus of claim 10, wherein when showing the download application, the control module stores information about the download application in the storage unit so that a window of the resident application is shown over a window of the download application.

12. The apparatus of claim 11, wherein when hiding the resident application, the control module recovers the information about the download application stored in the storage unit while clearing the information about the resident application from the storage unit so that a window of the download application partially overlapped by a window of the resident application to be hidden can be recovered.

13. The apparatus of claim 10, wherein when hiding the resident application, the control module recovers the information about a download application stored in the storage unit while clearing the information about a resident application from the storage unit so that a window of the download application partially overlapped by a window of the resident application to be hidden can be recovered.
